(19) United States
(12) Patent Application Publication
(10) Pub. No.: US 2015/0212204 A1
(43) Pub. Date: Jul. 30, 2015

(54) METHOD AND DEVICE FOR DETECTING SURROUNDINGS

(71) Applicant: Tsinghua University, Beijing (CN)

(72) Inventors: KE XU, Beijing (CN); YUCHAO ZHANG, Beijing (CN); WENLONG CHEN, Beijing (CN); YINGCHUAN ZHAO, Beijing (CN)

(21) Appl. No.: 14/458,033

(22) Filed: Aug. 12, 2014

(30) Foreign Application Priority Data
Jan. 24, 2014 (CN) 201410035352.0

(51) Int. Cl. G01S 13/08; G08B 21/18; G01C 21/20

(52) U.S. Cl. CPC G01S 13/08; G01C 21/20; G08B 21/18

(57) ABSTRACT

A method for detecting surroundings of a software radio is provided, wherein the software radio comprises a first directional antenna and a second directional antenna, and the method comprises: sending a directional signal towards a preset direction by the first directional antenna; receiving a return signal from the preset direction by the second directional antenna, and obtaining a round trip time according to the directional signal and the return signal; obtaining a distance between the software radio and an object in the preset direction according to the round trip time; adjusting the preset direction and repeating above steps, until distances between the software radio and objects in respective directions are obtained; obtaining the surroundings of the software radio according to the distances between the software radio and objects in respective distances.

### CROSS-REFERENCE TO RELATED APPLICATION

This application claims priority to and benefits of Chinese Patent Application Serial No. 201410035352.0, filed with the State Intellectual Property Office of P. R. China on Jan. 24, 2014, the entire content of which is incorporated herein by reference.

### FIELD

Embodiments of the present disclosure generally relate to a radio communication technology field, and more particularly to a method and a device for detecting surroundings.

### BACKGROUND

Surroundings are often unknown to people due to environment factors or human factors. Thus personal safety may be threatened and losses may be resulted when there is an obstacle or danger in the surroundings. For example, for people who work in a borehole, it is difficult to correctly sense surroundings to see underground roads clearly because of darkness, so accidents may happen; in addition, for blind people, they cannot perceive roads, obstacles in the roads or other potential hinders so accidents always happen. Therefore, if the surroundings cannot be detected effectively, there may be large safety issues and some people's assets, even life, may be threatened.

### SUMMARY

Embodiments of the present disclosure seek to solve at least one of the problems existing in the conventional technology to at least some extent.

According to embodiments of a first aspect of the present disclosure, a method for detecting surroundings of a software radio is provided, wherein the software radio comprises a first directional antenna and a second directional antenna. The method comprises steps of: sending a directional signal towards a preset direction by the first directional antenna; receiving a return signal from the preset direction by the second directional antenna, and obtaining a round trip time according to the directional signal and the return signal; obtaining a distance between the software radio and an object in the preset direction according to the round trip time; adjusting the preset direction and repeating above steps, until distances between the software radio and objects in respective directions are obtained; obtaining the surroundings of the software radio according to the distances between the software radio and objects in respective distances.

In one embodiment of the present disclosure, the method further comprises steps of: sending a test signal from the first directional antenna to the second directional antenna before sending the directional signal; judging whether the test signal is received by the second directional antenna correctly; and if no, sending an alarm.

In one embodiment of the present disclosure, obtaining a round trip time according to the directional signal Transmit(s) and the return signal comprises: obtaining a sending time of the directional signal; determining a reflected signal from the object in the preset direction according to the directional signal and the return signal, and obtaining a starting time of the reflected signal; and obtaining the round trip time according to the following formula,

T=t1−t0,

in which T is the round trip time, t1 is the starting time of the reflected signal, and t0 is the sending time of the directional signal.

In one embodiment of the present disclosure, the distance between the software radio and the object in the preset direction is obtained according to the following formula,

S=(v×T)/2,

in which, S is the distance between the software radio and the object in the preset direction, v is the velocity of signal, T is the round trip time.

In one embodiment of the present disclosure, the method further comprises steps of: detecting the surroundings of the software radio with a predetermined frequency to obtain a plurality of detecting results about the surroundings when a user of the software radio is moving; obtaining distances between the user and surrounding obstacles according to the plurality of detecting results so as to draw a physical environment map; and guiding the user according to the physical environment map.

With the method according to embodiments of the present disclosure, a plurality of round times of the signals sent from various directions and reflected from surrounding objects in the surroundings is obtained by the software radio, and distances between the surrounding objects and the software radio are obtained according to the plurality of round times, then the surroundings of the software radio can be detected timely and accurately, avoiding dangers and ensuring personal safety of the user as the user can respond to emergencies according to the detected surroundings when he is unable to see the current environment clearly. Especially for people who work in borehole and for the blind people, as surroundings are provided timely and accurately, their safety can be ensured and dangers can be reduced.

According to embodiments of a second aspect of the present disclosure, a device for detecting surroundings is provided. The device comprises: a transmitting module, configured to send a directional signal towards a preset direction; a receiving module, configured to receive a return signal from the preset direction; a first calculating module, configured to obtain a round trip time according to the directional signal and the return signal, to obtain a distance between the device and an object in the preset direction according to the round trip time; and a control module, configured to adjust the preset direction of the transmitting module and the receiving module, such that distances between the device and objects in respective directions are obtained.

In one embodiment of the present disclosure, the transmitting module is configured to send a test signal to the receiving module, and the device further comprises: a judging module, configured to judge whether the test signal is received by the receiving module; an alarming module, configured to send an alarm when the test signal is not received by the receiving module.

In one embodiment of the present disclosure, the first calculating module comprises: a first obtaining unit, configured to obtain a sending time of the directional signal; a second obtaining unit, configured to determine a reflected signal from the object in the preset direction according to the directional signal and the return signal, and to obtain a starting time of the reflected signal; and a third obtaining unit, configured to obtain the round trip time according to the following formula,

T=t1−t0,

in which T is the round trip time, t1 is the starting time of the reflected signal, and t0 is the sending time of the directional signal Transmit(s).

In one embodiment of the present disclosure, the first calculating module is further configured to obtain the distance between the device and the object in the preset direction according to the following formula,

S=(v×T)/2,

in which, S is the distance between the device and the object in the preset direction, v is the velocity of signal, T is the round trip time.

In one embodiment of the present disclosure, the transmitting module is further configured to send the directional signal with a predetermined frequency when a user of the device is moving, so as to obtain a plurality of detecting results about the surroundings, and the device further comprises: a second calculating module, configured to obtain distances between the user and surrounding obstacles according to the plurality of detecting results so as to draw a physical environment map; and a guiding module, configured to guide the user according to the physical environment map.

In one embodiment of the present disclosure, each of the transmitting module and the receiving module is configured as a directional antenna.

With the device according to embodiments of the present disclosure, a plurality of round times of the signals sent from various directions and reflected from surrounding objects the surroundings is obtained by the software radio, and distances between the surrounding objects and the software radio are obtained according to the plurality of round times, then the surroundings of the software radio can be detected timely and accurately, avoiding dangers and ensuring personal safety of the user as the user can respond to emergencies according to the detected surroundings when he is unable to see the current environment clearly. Especially for people who work in borehole and for the blind people, as surroundings are provided timely and accurately, their safety can be ensured and dangers can be reduced.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the accompanying drawings, in which:

FIG. 1 is a flow chart of a method for detecting surroundings of a software radio according to an embodiment of the present disclosure;

FIG. 2 is a schematic diagram of a return signal received by a second directional antenna according to an embodiment of the present disclosure;

FIG. 3 is a schematic diagram of surroundings of a software radio according to an embodiment of the present disclosure;

FIG. 4 is a flow chart of a method for detecting surroundings of a software radio according to another embodiment of the present disclosure;

FIG. 5 is a schematic diagram of sending a test signal according to an embodiment of the present disclosure;

FIG. 6 is a flow chart of a method for detecting surroundings of a software radio according to yet another embodiment of the present disclosure;

FIG. 7 is a block diagram of a device for detecting surroundings according to an embodiment of the present disclosure;

FIG. 8 is a block diagram of a device for detecting surroundings according to another embodiment of the present disclosure;

FIG. 9 is a block diagram of a device for detecting surroundings according to yet another embodiment of the present disclosure.

### DETAILED DESCRIPTION

Embodiments of the present disclosure will be described in detail in the following descriptions, examples of which are shown in the accompanying drawings, in which the same or similar elements and elements having same or similar functions are denoted by like reference numerals throughout the descriptions. The embodiments described herein with reference to the accompanying drawings are explanatory and illustrative, which are used to generally understand the present disclosure. The embodiments shall not be construed to limit the present disclosure.

It is to be understood that phraseology and terminology used herein (such as, terms like “center”, “longitudinal”, “lateral”, “length”, “width”, “thickness”, “up”, “down”, “front”, “rear”, “left”, “right”, “top”, “bottom”, “inside”, “outside”, “vertical”, “horizontal”, “clockwise” and “counterclockwise”) are only used to simplify description of the present invention, and do not indicate or imply that the device or element referred to must have or operated in a particular orientation. They cannot be seen as limits to the present disclosure.

It is to be understood that, in the description of the present disclosure, terms of “first” and “second” are only used for description and cannot be seen as indicating or implying relative importance. Unless otherwise stipulated and restricted, it is to be explained that terms of “linkage” and “connection” shall be understood broadly, for example, it could be mechanical connection or electrical connection; it could be direct linkage, indirect linkage via intermediate medium. Those skilled in the art shall understand the concrete notations of the terms mentioned above according to specific circumstances. Furthermore, unless otherwise explained, it is to be understood that a term of “a plurality of” refers to two or more.

Any procedure or method described in the flow charts or described in any other way herein may be understood to comprise one or more modules, portions or parts for storing executable codes that realize particular logic functions or procedures. Moreover, advantageous embodiments of the present disclosure comprises other implementations in which the order of execution is different from that which is depicted or discussed, including executing functions in a substantially simultaneous manner or in an opposite order according to the related functions. These and other aspects should be understood by those skilled in the art with reference to the following description and drawings. In these description and drawings, some particular implementations of the present disclosure are disclosed to present some ways for implementing the principle of the present disclosure. However, it should be understood that embodiments of the present disclosure is not limited to this. Contrarily, embodiments of the present disclosure include all the variations, modifications and equivalents within the spirit and scope of the appended claims.

In the following, a method and a device for detecting surroundings according to embodiments of the present disclosure will be described in detail with reference to drawings.

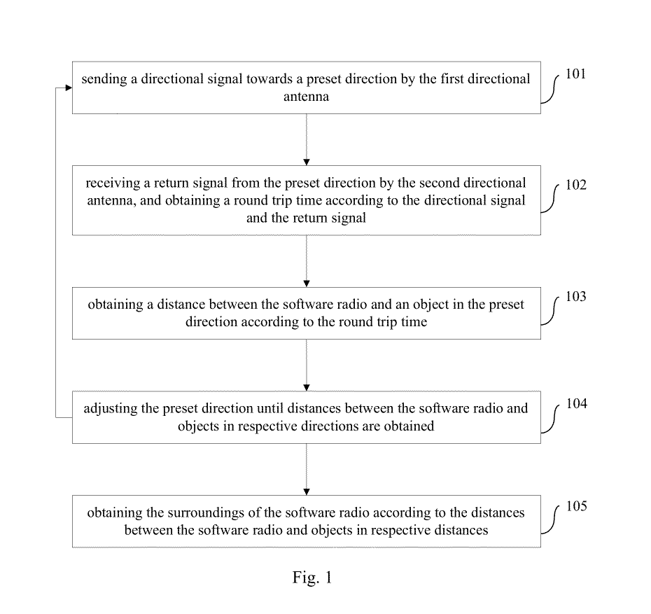

FIG. 1 is a flow chart of a method for detecting surroundings of a software radio according to an embodiment of the present disclosure. As shown in FIG. 1, the method comprises the following steps.

In embodiments of the present disclosure, a single transmission and single reception experiment system is deployed on a platform of a software radio with two antennas. The software radio is a radio broadcast communication technology without hardware connections but based on a radio communication protocols defined by software. The software radio can be reprogrammed and reconfigured to be applied in various situations such as various criterions or multi-band to implement various functions. In embodiments of the present disclosure, the software radio with two antennas is used to realize signal single transmission and signal single reception. One of the two antennas is used to send a signal and the other is used to receive a signal.

At step 101, a directional signal is sent towards a preset direction by the first directional antenna.

In embodiments of the present disclosure, signals sent by the first directional antenna may be a Wi-Fi (Wireless Fidelity) signal, so the signals can cover a wider area and have a higher response speed. In other embodiments of the present disclosure, the signals may be of other types, which is not limited in embodiments of the present disclosure.

At step 102, a return signal is received from the preset direction by the second directional antenna, and a round trip time is obtained according to the directional signal and the return signal.

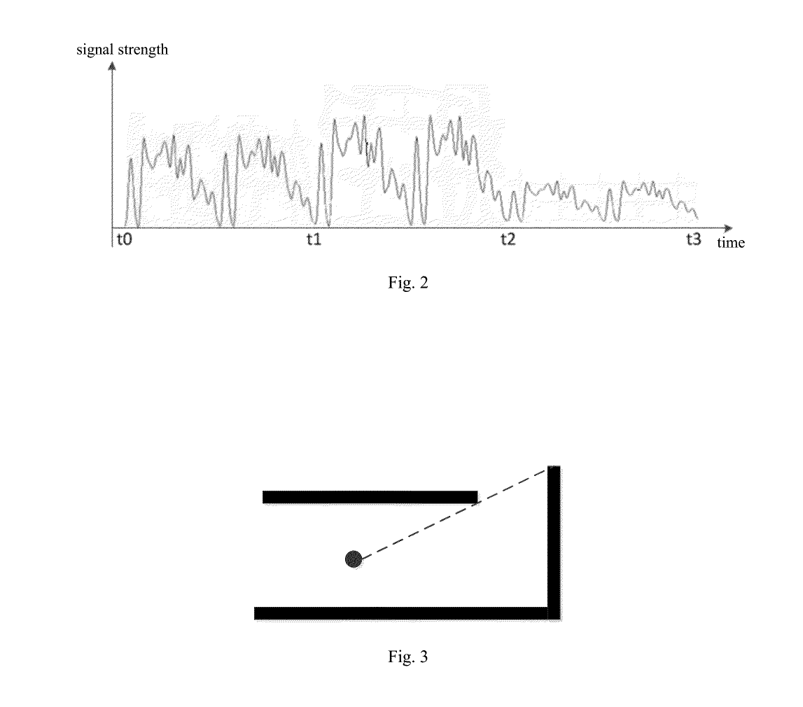

In embodiments of the present disclosure, as the second directional antenna is very close to the first directional antenna and an object in the preset direction is very far from the second directional antenna, the second directional antenna will receive the directional signal as soon as the first directional antenna send the test signal, and will receive a reflected signal from an object in the preset direction after some time (the round trip time). FIG. 2 is a schematic diagram of the return signal received by the second directional antenna according to an embodiment of the present disclosure. As shown in FIG. 2, the return signal is the directional signal in t0-t1 period; the return signal is a superposed signal comprising the directional signal and the reflected signal in t1-t2 period; and the return signal is only the reflected signal in t2-t3 period as the first directional antenna has stopped sending the directional signal. Therefore, it is necessary to eliminate the directional signal from the return signal to obtain the reflected signal.

Specially, a sending time of the directional signal is obtained first, then the reflected signal from the object in the preset direction is determined according to the directional signal and the return signal, and a starting time of the reflected signal is obtained, and the round trip time can be obtained according to the following formula,

T=t1−t0,

in which T is the round trip time, t1 is the starting time of the reflected signal, and t0 is the sending time of the directional signal.

In embodiments of the present disclosure, the software radio has a CPU (Central Processing Unit) with a processing speed of GHz level and a computation precision of nanosecond level, so the round trip time can be computed accurately.

At step 103, a distance between the software radio and an object in the preset direction is obtained according to the round trip time.

In embodiments of the present disclosure, the distance between the software radio and an object in the preset direction can be obtained according to the following formula,

S=(v×T)/2,

in which S is the distance between the software radio and the object in the preset direction, v is the velocity of signal, T is the round trip time.

At step 104, the preset direction is adjusted, and steps from 101 to 103 are repeated, until distances between the software radio and objects in respective directions are obtained.

At step 105, the surroundings of the software radio are obtained according to the distances between the software radio and objects in respective distances.

FIG. 3 is a schematic diagram of surroundings of a software radio according to an embodiment of the present disclosure.

With the method according to embodiments of the present disclosure, a plurality of round times of the signals sent from various directions and reflected from surrounding objects in the surroundings is obtained by the software radio, and distances between the surrounding objects and the software radio are obtained according to the plurality of round times, then the surroundings of the software radio can be detected timely and accurately, avoiding dangers and ensuring personal safety of the user as the user can respond to emergencies according to the detected surroundings when he is unable to see the current environment clearly. Especially for people who work in borehole and for the blind people, as surroundings are provided timely and accurately, their safety can be ensured and dangers can be reduced.

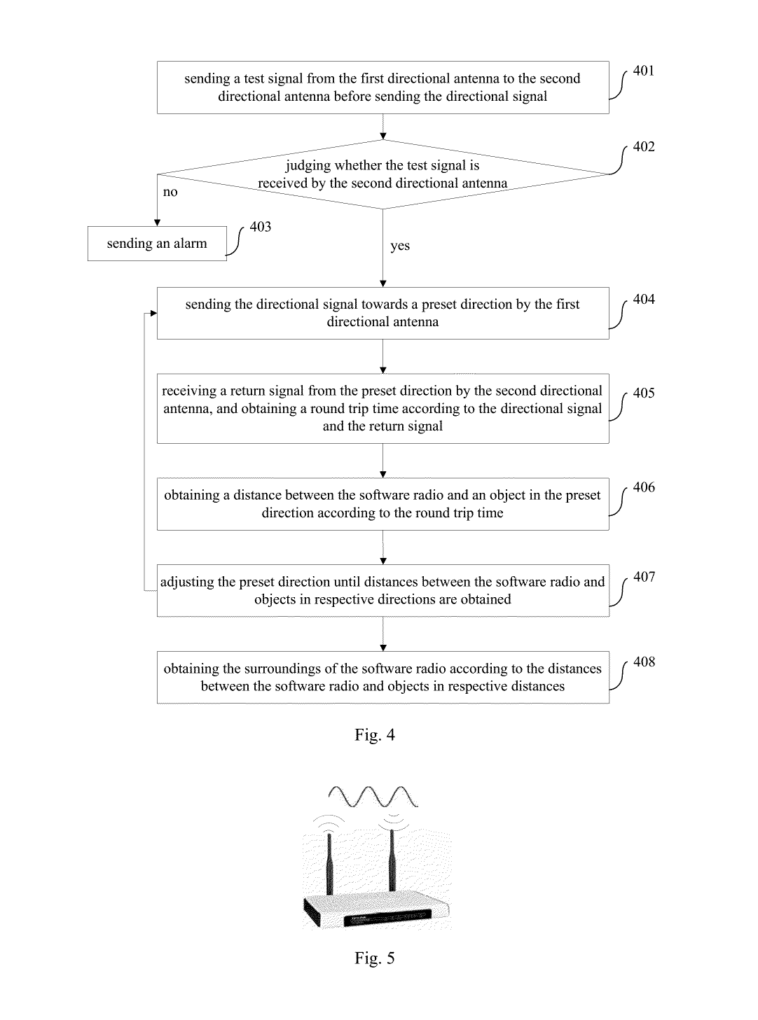

FIG. 4 is a flow chart of a method for detecting surroundings of a software radio according to another embodiment of the present disclosure and FIG. 5 is a schematic diagram of sending a test signal according to an embodiment of the present disclosure. With reference to FIG. 4 and FIG. 5, the method comprises the following steps.

At step 401, a test signal from the first directional antenna is sent to the second directional antenna before sending the directional signal.

At step 402, it is judged whether the test signal is received by the second directional antenna.

If the second directional antenna can receive the test signal, it means the software works well, and the surroundings of the software radio can be obtained by executing step 404 to step 408.

At step 403, if the test signal is not received by the second directional antenna, an alarm will be sent.

At step 404, a directional signal is sent towards a preset direction by the first directional antenna.

In embodiments of the present disclosure, signals sent by the first directional antenna can be a Wi-Fi (Wireless Fidelity) signal, so the signals can cover a wider area and have a higher response speed. In other embodiments of the present disclosure, the signals may be of other types, which is not limited in embodiments of the present disclosure.

At step 405, a return signal is received from the preset direction by the second directional antenna, and a round trip time is obtained according to the directional signal and the return signal.

In embodiments of the present disclosure, as the second directional antenna is very close to the first directional antenna and an object in the preset direction is very far from the second directional antenna, the second directional antenna will receive the directional signal as soon as the first directional antenna send the test signal, and will receive a reflected signal from an object in the preset direction after some time (the round trip time). FIG. 2 is a schematic diagram of the return signal received by the second directional antenna according to an embodiment of the present disclosure. As shown in FIG. 2, the return signal is the directional signal in t0-t1 period; the return signal is a superposed signal comprising the directional signal and the reflected signal in t1-t2 period; and the return signal is only the reflected signal in t2-t3 period as the first directional antenna has stopped sending the directional signal. Therefore, it is necessary to eliminate the directional signal from the return signal to obtain the reflected signal.

Specially, a sending time of the directional signal is obtained first, then the reflected signal from the object in the preset direction is determined according to the directional signal and the return signal, and a starting time of the reflected signal is obtained, and the round trip time can be obtained according to the following formula,

T=t1−t0,

in which T is the round trip time, t1 is the starting time of the reflected signal, and t0 is the sending time of the directional signal.

In embodiments of the present disclosure, the software radio has a CPU (Central Processing Unit) with a processing speed of GHz level and a computation precision of nanosecond level, so the round trip time can be computed accurately.

At step 406, a distance between the software radio and an object in the preset direction is obtained according to the round trip time.

In embodiments of the present disclosure, the distance between the software radio and an object in the preset direction can be obtained according to the following formula,

S=(v×T)/2,

in which S is the distance between the software radio and the object in the preset direction, v is the velocity of signal, T is the round trip time.

At step 407, the preset direction is adjusted, and steps from 404 to 406 are repeated, until distances between the software radio and objects in respective directions are obtained.

At step 408, the surroundings of the software radio are obtained according to the distances between the software radio and objects in respective distances.

With the method according to embodiments of the present disclosure, whether the second directional antenna works well is checked before detecting surroundings, and the alarm will be sent if the second directional antenna does not work well, thus avoiding potential security issues resulted from faults of the software radio.

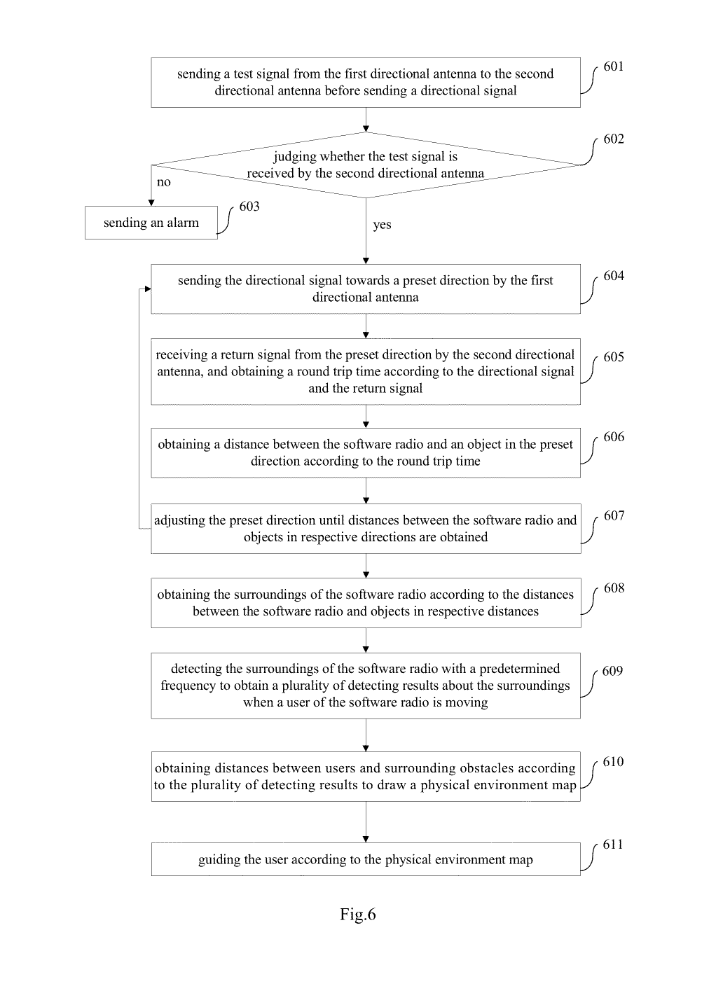

FIG. 6 is a flow chart of a method for detecting surroundings of a software radio according to yet another embodiment of the present disclosure. With reference to FIG. 6 and FIG. 5, the method comprises the following steps.

At step 601, a test signal from the first directional antenna is sent to the second directional antenna before sending the directional signal.

At step 602, it is judged whether the test signal is received by the second directional antenna.

If the second directional antenna can receive the test signal, it means the software works well, and the surroundings of the software can be obtained by executing step 404 to step 408.

At step 603, if the test signal is not received by the second directional antenna, an alarm will be sent.

At step 604, a directional signal is sent towards a preset direction by the first directional antenna.

In embodiments of the present disclosure, signals sent by the first directional antenna can be a Wi-Fi (Wireless Fidelity) signal, so the signals can cover a wider area and have a higher response speed. In other embodiments of the present disclosure, the signals may be of other types, which is not limited in embodiments of the present disclosure.

At step 605, a return signal is received from the preset direction by the second directional antenna, and a round trip time is obtained according to the directional signal and the return signal.

In embodiments of the present disclosure, as the second directional antenna is very close to the first directional antenna and an object in the preset direction is very far from the second directional antenna, the second directional antenna will receive the directional signal as soon as the first directional antenna send the test signal, and will receive a reflected signal from an object in the preset direction after some time (the round trip time). FIG. 2 is a schematic diagram of the return signal received by the second directional antenna according to an embodiment of the present disclosure. As shown in FIG. 2, the return signal is the directional signal in t0-t1 period; the return signal is a superposed signal comprising the directional signal and the reflected signal in t1-t2 period; and the return signal is only the reflected signal in t2-t3 period as the first directional antenna has stopped sending the directional signal. Therefore, it is necessary to eliminate the directional signal from the return signal to obtain the reflected signal.

Specially, a sending time of the directional signal is obtained first, then the reflected signal from the object in the preset direction is determined according to the directional signal and the return signal, and a starting time of the reflected signal is obtained, and the round trip time can be obtained according to the following formula,

T=t1−t0,

in which T is the round trip time, t1 is the starting time of the reflected signal, and t0 is the sending time of the directional signal.

In embodiments of the present disclosure, the software radio has a CPU (Central Processing Unit) with a processing speed of GHz level and a computation precision of nanosecond level, so the round trip time can be computed accurately.

At step 606, a distance between the software radio and an object in the preset direction is obtained according to the round trip time.

In embodiments of the present disclosure, the distance between the software radio and an object in the preset direction can be obtained according to the following formula,

S=(v×T)/2,

in which S is the distance between the software radio and the object in the preset direction, v is the velocity of signal, T is the round trip time.

At step 607, the preset direction is adjusted, and steps from 404 to 406 are repeat, until distances between the software radio and objects in respective directions are obtained.

At step 608, the surroundings of the software radio are obtained according to the distances between the software radio and objects in respective distances.

At step 609, a plurality of detecting results about the surroundings is obtained by detecting the surroundings of the software radio with a predetermined frequency when a user of the software radio is moving.

At step 610, distances between the user and surrounding obstacles are obtained according to the plurality of detecting results, and then a physical environment map is drawn.

At step 611, the user is guided according to the physical environment map.

As shown in FIG. 3, when the user is at the position of a dot in FIG. 3, a guidance of “turn left after 50 meters” will be guided to the user.

With the method according to embodiments of the present disclosure, the surroundings is detected according to position changes of the user, and then road guidance can be sent to the user, clearing the surroundings and further providing guarantee for the personal safety of the user.

A device for detecting surroundings is further provided according to embodiments of the present disclosure.

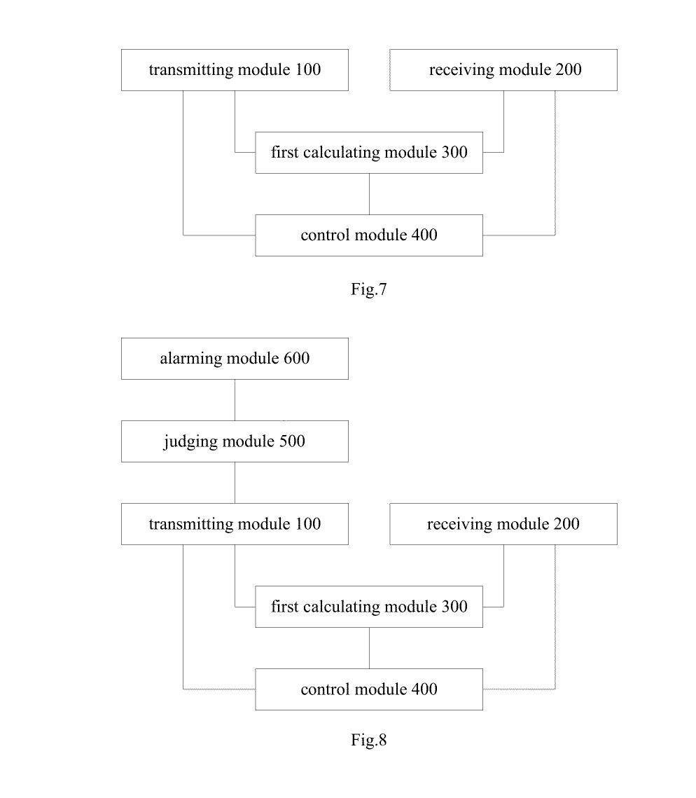

FIG. 7 is a block diagram of a device for detecting surroundings according to an embodiment of the present disclosure. As shown in FIG. 7, the device for detecting surroundings comprises a transmitting module 100, a receiving module 200, a first calculating module 300 and a control module 400.

In embodiments of the present disclosure, the device for detecting surroundings can be a software radio. The software radio is a radio broadcast communication technology without hardware connections but based on a radio communication protocols defined by software. The software radio can be reprogrammed and reconfigured to be applied in various situations such as various criterions or multi-band to implement various functions. In embodiments of the present disclosure, the software radio with two antennas is used to realize signal single transmission and signal single reception. One of the two antennas is used to send a signal and the other is used to receive a signal.

Specifically, the transmitting module 100 is configured to send a directional signal towards a preset direction. In embodiments of the present disclosure, the transmitting module 100 can be the first directional antenna, and signals sent by the first directional antenna can be a Wi-Fi (Wireless Fidelity) signal, so the signals can cover a wider area and have a higher response speed. In other embodiments of the present disclosure, the signals may be of other types, which is not limited in embodiments of the present disclosure.

The receiving module 200 is configured to receive a return signal from the preset direction. In embodiments of the present disclosure, the receiving module 200 can be the second directional antenna.

The first calculating module 300 is configured to obtain a round trip time according to the directional signal and the return signal, to obtain a distance between the software radio and an object in the preset direction according to the round trip time.

In embodiments of the present disclosure, as the receiving module 200 is very close to the transmitting module 100 and an object in the preset direction is very far from the software radio, the receiving module 200 will receive the directional signal as soon as the transmitting module 100 send the test signal, and will receive a reflected signal from an object in the preset direction after some time (the round trip time). FIG. 2 is a schematic diagram of the return signal received by the s receiving module 200 according to an embodiment of the present disclosure. As shown in FIG. 2, the return signal received by the receiving module 200 is the directional signal in t0-t1 period; the return signal received by the receiving module 200 is a superposed signal comprising the directional signal and the reflected signal in t1-t2 period; and the return signal received by the receiving module 200 is only the reflected signal in t2-t3 period as the transmitting module 100 has stopped sending the directional signal. Therefore, it is necessary to eliminate the directional signal from the return signal to obtain the reflected signal.

More specially, in one embodiment of the present disclosure, the first calculating module 300 comprises a first obtaining unit 310, a second obtaining unit 320 and a third obtaining unit 330. The first obtaining unit 310 is configured to obtain a sending time of the directional signal. The second obtaining unit 320 is configured to determine a reflected signal from the object in the preset direction according to the directional signal and the return signal, and to obtain a starting time of the reflected signal. The third obtaining unit 330 is configured to obtain the round trip time according to the following formula,

T=t1−t0,

in which T is the round trip time, t1 is the starting time of the reflected signal, and t0 is the sending time of the directional signal Transmit(s).

In embodiments of the present disclosure, the first calculating module 300 can obtain the round trip time by a CPU (Central Processing Unit) with a processing speed of GHz level and a computation precision of nanosecond level, so the round trip time can be computed accurately.

In embodiments of the present disclosure, the first calculating module 300 is further configured to obtain the distance between the device and the object in the preset direction according to the following formula,

S=(v×T)/2,

in which, S is the distance between the device and the object in the preset direction, v is the velocity of signal, T is the round trip time.

The control module 400 is configured to adjust the preset direction of the transmitting module and the receiving module, such that distances between the software radio and objects in respective directions are obtained.

So the surroundings of the device can be obtained according to the distances between the device and objects in respective distances.

With the device according to embodiments of the present disclosure, a plurality of round times of the signals sent from various directions and reflected from surrounding objects the surroundings is obtained by the software radio, and distances between the surrounding objects and the software radio are obtained according to the plurality of round times, then the surroundings of the software radio can be detected timely and accurately, avoiding dangers and ensuring personal safety of the user as the user can respond to emergencies according to the detected surroundings when he is unable to see the current environment clearly. Especially for people who work in borehole and for the blind people, as surroundings are provided timely and accurately, their safety can be ensured and dangers can be reduced.

FIG. 8 is a block diagram of a device for detecting surroundings according to another embodiment of the present disclosure. As shown in FIG. 8, the device for detecting surroundings comprises a transmitting module 100, a receiving module 200, a first calculating module 300, a control module 400, a judging module 500 and an alarming module 600.

Specifically, the transmitting module 100 is further configured to send a test signal to the receiving module. FIG. 5 is a schematic diagram of sending a test signal according to an embodiment of the present disclosure.

The judging module 500 is configured to judge whether the test signal is received by the receiving module. If the receiving module 200 can receive the test signal, the device works well, and the surroundings can be detected by the device.

The alarming module 600 is configured to send an alarm when the test signal is not received by the receiving module.

With the device according to embodiments of the present disclosure, whether the second directional antenna works well is checked before detecting surroundings, and the alarm will be sent if the second directional antenna does not work well, thus avoiding potential security issues resulted from faults of the software radio.

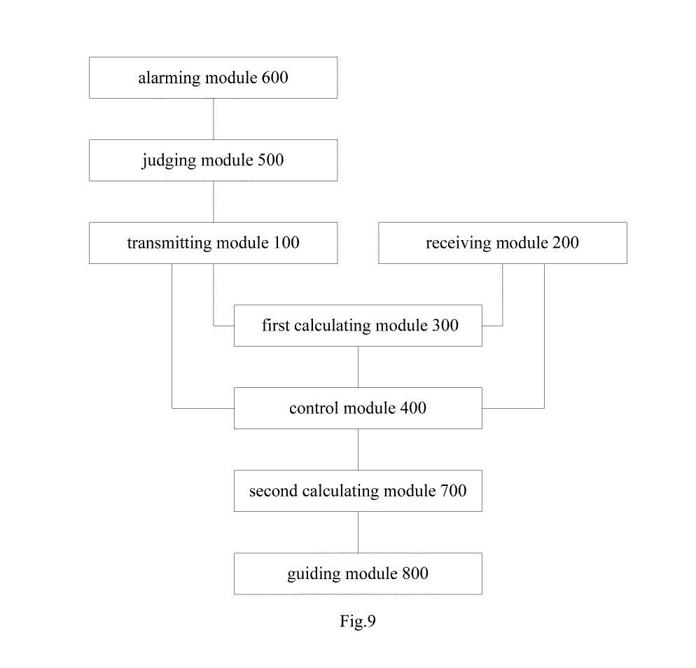

FIG. 9 is a schematic diagram of a device for detecting surroundings according to yet another embodiment of the present disclosure. As shown in FIG. 9, the device for detecting surroundings comprises a transmitting module 100, a receiving module 200, a first calculating module 300, a control module 400, a judging module 500, an alarming module 600, a second calculating module 700 and a guiding module 800.

Specifically, the transmitting module 100 is further configured to send the directional signal with a predetermined frequency when a user of the device is moving, so as to obtain a plurality of detecting results about the surroundings.

The second calculating module 700 is configured to obtain distances between the user and surrounding obstacles according to the plurality of detecting results so as to draw a physical environment map.

The guiding module 800 is configured to guide the user according to the physical environment map. As shown in FIG. 3, when the user is at the position of a dot in FIG. 3, a guidance of “turn left after 50 meters” will be guided to the user.

With the device according to embodiments of the present disclosure, the surroundings is detected according to position changes of the user, then road guidance can be sent to the user, clearing the surroundings and further providing guarantee for the personal safety of the user.

Any procedure or method described in the flow charts or described in any other way herein may be understood to comprise one or more modules, portions or parts for storing executable codes that realize particular logic functions or procedures. Moreover, advantageous embodiments of the present disclosure comprises other implementations in which the order of execution is different from that which is depicted or discussed, including executing functions in a substantially simultaneous manner or in an opposite order according to the related functions. This should be understood by those skilled in the art which embodiments of the present disclosure belong to.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment.

It is understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs comprise one or a combination of the steps in the method embodiments of the present disclosure when run on a computer.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. The appearances of the phrases throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A method for detecting surroundings with a software radio, wherein the software radio comprises a first directional antenna and a second directional antenna, and the method comprises:
sending a directional signal towards a preset direction by the first directional antenna;
receiving a return signal from the preset direction by the second directional antenna, and obtaining a round trip time according to the directional signal and the return signal;
obtaining a distance between the software radio and an object in the preset direction according to the round trip time;
adjusting the preset direction and repeating above steps, until distances between the software radio and objects in respective directions are obtained;
obtaining the surroundings of the software radio according to the distances between the software radio and objects in respective distances.

2. The method according to claim 1, further comprising:
sending a test signal from the first directional antenna to the second directional antenna before sending the directional signal;
judging whether the test signal is received by the second directional antenna; and
if no, sending an alarm.

3. The method according to claim 1, wherein obtaining a round trip time according to the directional signal Transmit(s) and the return signal comprises:
obtaining a sending time of the directional signal;
determining a reflected signal from the object in the preset direction according to the directional signal and the return signal, and obtaining a starting time of the reflected signal; and
obtaining the round trip time according to the following formula,
T=t1−t0,
in which T is the round trip time, t1 is the starting time of the reflected signal, and t0 is the sending time of the directional signal.

4. The method according to claim 1, wherein the distance between the software radio and the object in the preset direction is obtained according to the following formula,
S=(v×T)/2,
in which, S is the distance between the software radio and the object in the preset direction, v is a velocity of signal, T is the round trip time.

5. The method according to claim 1, further comprising:
detecting the surroundings of the software radio with a predetermined frequency to obtain a plurality of detecting results about the surroundings when a user of the software radio is moving;
obtaining distances between the user and surrounding obstacles according to the plurality of detecting results to draw a physical environment map; and
guiding the user according to the physical environment map.

6. A device for detecting surroundings, comprising:
a transmitting module, configured to send a directional signal towards a preset direction;
a receiving module, configured to receive a return signal from the preset direction;
a first calculating module, configured to obtain a round trip time according to the directional signal and the return signal, to obtain a distance between the device and an object in the preset direction according to the round trip time; and
a control module, configured to adjust the preset direction of the transmitting module and the receiving module, such that distances between the device and objects in respective directions are obtained.

7. The device according to claim 6, wherein the transmitting module is configured to send a test signal to the receiving module, and the device further comprises:
a judging module, configured to judge whether the test signal is received by the receiving module;
an alarming module, configured to send an alarm when the test signal is not received by the receiving module.

8. The device according to claim 6, wherein the first calculating module comprises:
a first obtaining unit, configured to obtain a sending time of the directional signal;
a second obtaining unit, configured to determine a reflected signal from the object in the preset direction according to the directional signal and the return signal, and to obtain a starting time of the reflected signal; and
a third obtaining unit, configured to obtain the round trip time according to the following formula,
T=t1−t0,
in which T is the round trip time, t1 is the starting time of the reflected signal, and t0 is the sending time of the directional signal Transmit(s).

9. The device according to claim 6, wherein the first calculating module is further configured to obtain the distance between the device and the object in the preset direction according to the following formula,
S=(v×T)/2,
in which, S is the distance between the device and the object in the preset direction, v is the velocity of signal, T is the round trip time.

10. The device according to claim 6, wherein the transmitting module is further configured to send the directional signal with a predetermined frequency when a user of the device is moving, so as to obtain a plurality of detecting results about the surroundings, and the device further comprises:
a second calculating module, configured to obtain distances between the user and surrounding obstacles so as to draw a physical environment map; and
a guiding module, configured to guide the user according to the physical environment map.

11. The device according to claim 6, wherein each of the transmitting module and the receiving module is configured as a directional antenna.
